(19) United States
(12) Patent Application Publication
(10) Pub. No.: US 2024/0026188 A1
(43) Pub. Date: Jan. 25, 2024

(54) METHOD OF APPLYING AN ADHESIVE FILM

(71) Applicant: PPG Advanced Surface Technologies, LLC, Coloumbus, OH (US)

(72) Inventors: Daniel Mencel, Esslingen (DE); Jörg Eisenlohr, Nagold (DE)

(73) Assignee: PPG Advanced Surface Technologies, LLC, Columbus, OH (US)

(21) Appl. No.: 18/256,812

(22) PCT Filed: Nov. 26, 2021
(86) PCT No.: PCT/EP2021/083075

§ 371 Date: Jun. 9, 2023

(30) Foreign Application Priority Data
Dec. 11, 2020 (DE) 102020215764.2

(51) Int. Cl. C09J 7/32

(52) U.S. Cl. CPC C09J 7/32; C09J 2301/50; C09J 2301/416

(57) ABSTRACT

In a method for applying an adhesive film (10) to the surface (20) of a component, an adhesive film (10) including an adhesive layer (11) is provided. Furthermore, a component including a surface (20) to which the adhesive film is to be applied is provided. A physical surface activation of the adhesive layer (11) of the adhesive film (10) is carried out. The adhesive layer (11) of the adhesive film (10) is moistened before the surface-activated and moistened adhesive film (10) is brought in contact with the surface (20) of the component to which the adhesive film is to be applied.

The present invention relates to a method for applying an adhesive film to the surface of a component and to a device suitable for carrying out this method.

### FIELD OF APPLICATION AND PRIOR ART

Adhesive films are used in many application areas, for example for decorative purposes, such as to transfer a color pattern onto a surface, for functional reasons, for example as protection for painted surfaces, or to apply lettering and the like. Especially, adhesive films are increasingly used in the series production of motor vehicles, for example as stone guard, to apply model designations and the like, as well as, of course, for visual design purposes.

The effort that arises, for example, when applying a color pattern by means of an adhesive film is generally significantly less than when creating such patterns in a multi-stage painting process. However, the application of the adhesive films in series production is anything but trivial. The larger the adhesive film, the more difficult it is to position the adhesive film correctly on the surface to which the adhesive film is to be applied and to adhesively bond it without entrapped air and the formation of wrinkles. These processes have not been successfully automated thus far. As a result, adhesive films, for example in the series production of motor vehicles, to this day are generally applied manually.

Adhesive films are known from U.S. Pat. No. 6,197,397 B1 which comprise microstructured channels within the adhesive layer. These channels are intended to allow air to escape during the application of the adhesive films to avoid entrapped air and render manual refinishing for removal of the air superfluous. These films are therefore better suited for automated processing than traditional adhesive films without the microstructured channels.

However, such adhesive films are very expensive. Due to the microstructured adhesive layer, they are furthermore less suited for creating high-quality surfaces. Adhesive films in general comprise a carrier film, one side of which is covered with an adhesive layer and the other side of which is covered with an optionally multi-layer paint coat. When using very thin carrier films, the microstructure leaves visible traces behind, even after they have been adhesively attached. The use of particularly thick adhesive films is generally not desired. Admittedly, the problem can be solved with thick films. However, these increase the thickness of the substrate a great deal. Unless the substrate is coated again with a clear coat, this approach also does not produce satisfactory results.

A method and a tool for applying an adhesive film to the surface of a workpiece or component, which address the aforementioned problems, are known from WO 2020/148070 A1. To this end, an adhesive film including an adhesive layer is positioned between the surface to which the adhesive film is to be applied and an elastic membrane with the aid of an automated system. As a result of a negative pressure that is applied between the membrane and the surface, the membrane becomes curved, forming a convex side and a concave side in the direction of the surface, until the membrane, leading with the convex side, makes contact with the surface so that the adhesive layer of the adhesive film is pressed against the surface by the membrane across the entire surface area. The degree of curvature of the membrane is controlled by harmonizing the pressure conditions on the two sides of the membrane. As a result, it is possible, for example, to support the curvature of the membrane created by the application of the negative pressure with a positive pressure on the back of the membrane.

The problem with these conventional methods can be inadequate adhesion of the adhesive film to the workpiece or component during the process of applying the film. Even if this inadequate adhesion possibly only occurs in partial regions of the contact surface between the adhesive film and the workpiece, this may cause undesirable entrapped air and blistering.

When applying adhesive films, for example during the manufacture of motor vehicles, it is frequently helpful for the application of adhesive films to first wet the adhesive layer of the adhesive film with water before positioning the adhesive film on the surface to which the adhesive film is to be applied. This wetting is generally carried out by hand, wherein dosing of the water is difficult. A frequent problem that arises in the process is that too much water is applied, so that subsequently, after the adhesive film has been applied, water exits laterally from the contact region between the adhesive film and the surface, and that a non-uniform bonding result is obtained or the adhesive film slides out of place.

### Problem and Solution

In contrast, it is the object of the invention described hereafter to provide an improved method and an improved device for applying an adhesive film to a component. In particular, an automatable method and a device for applying adhesive films are to be developed, which can be integrated into a series production operation, for example into a manufacturing line provided for the production of motor vehicles.

To achieve this object, the invention provides a method comprising the steps described in claim and a device having the features described in claim 7. Refinements of the invention are the subject matter of dependent claims.

The method according to the invention for applying an adhesive film to the surface of a component always comprises the following steps:
a. providing an adhesive film including an adhesive layer;
b. providing a component including a surface to which the adhesive film is to be applied;
c. carrying out a physical surface activation of the adhesive layer of the adhesive film;
d. moistening the adhesive layer of the adhesive film; and
e. bringing the surface-activated and moistened adhesive film in contact with the surface of the component to which the adhesive film is to be applied.

It was found that the bonding process or the application of the adhesive film can be considerably improved and simplified by the physical surface activation of the adhesive layer of the adhesive film in conjunction with subsequent moistening of the adhesive layer, prior to bringing the surface-activated and moistened adhesive film in contact with the surface to which the adhesive film is to be applied. Using this method, it is in particular possible to apply the adhesive film to the component particularly uniformly, without trapped air, imperfections or other undesirable inaccuracies occurring during the application of the adhesive film. Using the method according to the invention, especially optimal moistening of the adhesive layer is possible, so that neither too little nor too much moisture is applied to the adhesive layer.

According to the invention, a uniform and thin water film is preferably applied to the adhesive layer for moistening after the surface activation. This allows imperfections in the adhesive layer to be compensated for, whereby a very uniform bonding result is achieved. In principle, it is also possible to effectuate the moistening with an aqueous solution or a suspension. Instead of water, in principle the use of an organic solvent or solvent/water mixture is also conceivable, but in general is not preferred.

In particular, moistening after the surface activation is particularly advantageous in instances in which the adhesive-side surface area of the adhesive film is deliberately roughened to enhance adhesion. In many instances, satisfactory uniform and visually flawless adherence of the adhesive film roughened on the adhesive side is only possible with the aid of moistening of the adhesive layer. As a result of the preceding physical surface activation of the adhesive layer according to the invention, it is possible to optimize the moistening as needed. Using this method, capillary actions in the adhesive layer can be utilized particularly advantageously for applying an adhesive film to different surfaces without blistering.

Another particular advantage of the method according to the invention is that the method is readily amenable to automation. In this respect, the method according to the invention can be used, for example, particularly advantageously during the manufacture of motor vehicles. When applying adhesive films, for example labels, to the finished coating of a motor vehicle body, the wetting of the adhesive side of the adhesive film with water and the subsequent application of the adhesive film are conventionally carried out manually. Uniform wetting, during which not too much water and not too little water is applied, is very difficult, leading to unsatisfactory bonding results in some circumstances. In addition, the staffing expenditure is very high for this process. These problems are solved by the method according to the invention.

The physical surface activation of the adhesive layer in particular increases the surface energy of the adhesive layer. It was observed that this causes the wettability of the adhesive layer with water to be increased. The surface activation in particular causes the molecular structures in the adhesive layer to be broken up. This excitation of the adhesive layer can induce, above all, hydrophilic properties of the surface, which promote the wetting with water or with an aqueous solution. In general, this excited or activated state of the surface does not last long so that the molecule structures revert to the original state after a certain duration, for example after approximately 30 minutes or optionally less. The above steps d. and e. of the method according to the invention are thus expediently carried out within a limited time period after the surface activation. Between the physical surface activation of the adhesive layer and the subsequent moistening, preferably no more than 30 minutes should pass until the adhesive film is brought in contact with the surface of the component. In particularly preferred embodiments, the entire process of the surface activation, moistening and bringing-in-contact requires no more than 20 minutes, most particularly preferably no more than 10 minutes, and in particular no more than 5 minutes.

The surface energy of a substrate is generally indicated as energy per area using the unit J/m², frequently the equivalent unit N/m or dyn/cm also being used. As a result of the physical surface activation in accordance with the method according to the invention, a surface energy that is preferably ≥50 dyn/cm, particularly preferably ≥60 dyn/cm, and particularly preferably ≥70 dyn/cm is achieved. The inventors were able to demonstrate that, in particular at a surface energy of ≥60 dyn/cm, and most particularly at a surface energy of ≥70 dyn/cm, the wettability with water is so good that the moistening according to the aforementioned method step d. can be adjusted and adapted to the particular conditions particularly well.

The surface energy is particularly preferably determined according to DIN ISO 8296 using test inks, wherein in a rapid method it is possible to estimate the surface energy of the particular solid surface. In the process, commercially available test inks having a respective known surface energy or surface tension, in the case of liquids the surface energy is to be equated with the surface tension, are applied to the solid surface and observed in terms of the time within which the test ink breaks up into droplets on the surface. When examining several test inks in this way, the test ink that no longer breaks up into droplets within the first few seconds after application is identified. In this test ink, the surface energy of which is known, the surface energy of the solid surface agrees with that of the test ink.

The adhesive film is, for example, a decor, lettering or one or more individual letters or decorative elements to be applied to the surface to which the adhesive film is to be applied. In particular, these may be self-adhesive decorative paint films or decorative films including adhesive backings. The adhesive film can furthermore be stone guard films, which are known per se, or other protective films.

In a preferred refinement of the invention, the adhesive film that can be used in the method is characterized by at least one of the features a. to h. listed directly below:
a. the adhesive film comprises a carrier film, which has the adhesive layer on one side and a paint layer on the other;
b. the carrier film is a plastic film, a metal film or a metal-plastic composite film;
c. the carrier film has a thickness in the range of 10 μm to 120 nm;
d. the adhesive layer has a thickness in the range of 10 μm to 80 μm, and preferably of 30 μm to 60 μm;
e. the adhesive layer has a uniform thickness;
f. the adhesive layer is made of a homogeneous adhesive mass;
g. the adhesive layer has a surface area in the range of 10 cm² to 8 m²;
h. the paint layer has a thickness in the range of 20 μm to 150 μm, preferably of 30 μm to 90 μm, and particularly preferably of 40 μm to 60 μm.

Particularly preferably, at least features a. and b. and g. listed directly above are implemented in combination with one another. In a preferred refinement, features a. to d. and g. and h., and in particular a. to e. and g. and h., and in a particularly preferred embodiment, all features a. to h., are implemented in combination with one another.

Feature e. mentioned directly above is particularly preferably implemented in combination with feature f. A uniform thickness shall be understood to mean that the adhesive layer is not locally weakened by microstructure channels for removing air or other microstructures. It is preferably formed by the application of a homogeneous adhesive mass by means of a doctor blade and accordingly has a substantially planar and even surface. “Homogeneous” shall be understood to mean that the adhesive mass does not contain any particles, in particular visible particles.

The use of microstructure-free adhesive layers makes it possible to use adhesive films having very thin carriers in the method according to the invention, and nonetheless to be able to obtain a high-gloss “Class A surface” in the process. Within the above-described range of 10 μm to 120 μm, carrier films having a thickness of 10 μm to 60 μm, preferably of 10 μm to 50 μm, are thus further preferred, in particular when the adhesive layer is free of the aforementioned microstructures.

In a particularly preferred manner, the adhesive layer can be formed by an acrylate adhesive, preferably having a layer thickness in the range of 20 to 80 μm, and in particular having a layer thickness of 50 μm.

With respect to the physical surface activation, the method according to the invention preferably has at least one of the additional features a. to d. listed directly below:
a. carrying out the physical surface activation of the adhesive layer by a plasma treatment;
b. carrying out the physical surface activation of the adhesive layer by a corona treatment;
c. carrying out the physical surface activation of the adhesive layer by a flame treatment;
d. carrying out the physical surface activation of the adhesive layer under vacuum.

A plasma treatment is in particular suitable for the method according to the invention since a plasma treatment allows the surface activation of the adhesive layer of the adhesive film to be achieved very effectively and in a manner that can be implemented very well in practice. A plasma is a cloud comprising an at least partially ionized gas, as a result of the influence of which an increase in the surface energy is achieved for the surface activation of the adhesive layer. Suitable plasma generators are commercially available.

In principle, the plasma treatment can be carried out at atmospheric pressure or at positive pressure (high-pressure plasma) or negative pressure (low-pressure plasma). In particular, a low-pressure plasma is suitable for the purpose of the method according to the invention, especially a plasma treatment under vacuum. A vacuum shall preferably be understood to mean a pressure<0.05 mbar, for example a pressure of approximately 0.02 mbar. Accordingly, features a. and d. listed directly above are particularly preferred in combination. The surface activation in this case can in particular take place within a treatment chamber (plasma chamber) to be evacuated, into which the adhesive film including the adhesive layer to be activated is transferred. The treatment times for the plasma treatment can be in a range of 10 s to 120 s, for example.

In other cases, it may be preferred to use a so-called cold plasma in which, in principle, atmospheric pressure conditions are present, and in particular also no increase in the temperature during the formation of the plasma occurs.

A corona treatment is also a suitable alternative to a plasma treatment for the physical surface activation. A corona treatment is based on a gas discharge method, which results in an increase in the surface energy of the treated surface, and thus in improved wettability with water. In the process, an electric discharge occurs in general between the two electrodes under atmospheric pressure, wherein the gas molecules in the gas, and in particular in the air, are excited by the resulting electric field, and are optionally split. The resulting charged reactive particles react with the adhesive layer and thus lead to the surface activation. Compared to such a corona treatment, the plasma treatment in general has the advantage that a stronger increase in the surface energy can be achieved by way of the plasma, and that in general the activation of the surface lasts longer with a plasma than with a corona treatment.

Furthermore, a flame treatment is suitable for the physical surface activation of the adhesive layer. In the case of a flame treatment, the adhesive layer of the adhesive film is exposed to a flame of an air/gas mixture, wherein a stable and oxidizing flame is produced. The surface-activating effect of the adhesive layer can also be achieved in this way, so that the wettability with water is improved. A corona treatment, and in particular a plasma treatment, in general have the advantage over a flame treatment that a more uniform result can in general be achieved thereby across the surface area.

A unit for the physical surface activation, and in particular a plasma treatment unit, can particularly advantageously be an integral part of an automated device for applying the adhesive film.

In a most particularly preferred design of the method according to the invention, the method is characterized by the additional feature a. listed directly below:
a. moistening the adhesive layer by the atomization of water.

The atomization of water particularly advantageously makes it possible to create a defined amount of water in the form of fine water droplets in the region of the adhesive layer, wherein the water droplets are deposited onto the adhesive layer and thereby form the water film on the adhesive layer which is intended for the further application of the adhesive film.

When water is atomized, the water is distributed with the finest distribution in the gaseous environment, and in particular in the air. The atomization preferably results in a distribution of very small water drops in the air, which cause moistening of the adhesive layer. The water drops in the air during atomization preferably have an average diameter in a range between approximately 1 and 10 μm, particularly preferably between 2 and 5 μm, and most particularly preferably between 2 and 4 μm.

The water film resulting from the deposition of the water droplets on the adhesive layer is preferably very thin. The droplets are preferably distributed on the adhesive layer due to the moistening in such a way that these form a continuous film, which in particular has a thickness in a range of 1 nm to 1000 μm. The thickness of the water film is particularly preferably in a range of 10 nm to 500 μm, most particularly preferably in a range of 10 nm to 1000 nm, and preferably 10 nm to 100 nm. The water film should in particular be so thick that the irregularities in the adhesive layer can be compensated for by the water film.

The atomization can particularly advantageously be effectuated by way of an ultrasonic atomizer, wherein the water is made to oscillate by the acting ultrasound. This causes droplets to detach. The size of the droplets can be influenced by adjusting the frequency of the ultrasound. The higher the ultrasound frequency, the finer are the resulting droplets. In this respect, an ultrasonic atomizer is particularly advantageously suited for moistening the adhesive layer. The moistening or the atomization can be adjusted in such a way that the resulting water film on the adhesive layer is sufficient to compensate for the irregularities in the adhesive layer. The formation of larger droplets should expediently be avoided, which can in particular also be adjusted by the moistening duration.

Furthermore, a conventional spray gun is suitable for moistening the surface-activated adhesive layer. The spray gun can be actuated by way of a lifting cylinder, for example. By adjusting the cylinder stroke speed and/or the extension distance or the cylinder stroke, the intensity of the moistening can be varied to achieve a uniformly wetted adhesive layer.

Furthermore, it is possible to use a table including a movable XY head for moistening, which carries a moistening unit, such as a spray gun. The XY head can be used in a manner comparable to a 3D printer so as to travel across the surface to be moistened.

A unit for moistening the adhesive layer of the adhesive film, for example an ultrasonic atomizer or a spray gun, can particularly advantageously be an integral part of an automated device for applying the adhesive film.

In a preferred design of the method according to the invention, the method is characterized by the additional feature a. listed directly below:
a. bringing the adhesive film in contact with the surface to which the adhesive film is to be applied by initially pressing the adhesive film in a localized manner onto the surface to which the adhesive film is to be applied.

As a result of the initial localized pressing of the adhesive film onto the surface to which the adhesive film is to be applied, it is achieved that the contact region can subsequently continue radially outwardly until the adhesive layer makes contact with the surface across the entire surface area, resulting very reliably in a uniform and blister-free adhesive bond. This initial localized pressing-on of the adhesive film can in particular be carried out by means of at least one ram means, which pushes the adhesive film in a localized manner against the surface to which the adhesive film is to be applied. The ram means can particularly advantageously be an integral part of an automated device for applying the adhesive film. Such a ram means can, for example, comprise a cylinder, an extendable piston, and a ram head, in particular a rounded ram head.

When providing the adhesive film including the adhesive layer, it may in particular be provided that a protective film protecting the adhesive layer is removed in advance, and the adhesive film is then suspended or clamped in a unit for further carrying out the method. For example, a carrier film, to which the adhesive film is being attached, can be provided for this purpose. For example, the carrier film can be part of a device by way of which the surface-activated and moistened adhesive film is attached to the component to which the adhesive film is to be applied or the surface thereof. The adhesive film can in particular adhere with the side facing away from the adhesive layer to the carrier film, so that the side of the adhesive film including the adhesive layer is free and can be brought in contact with the surface of the component.

In a particularly preferred design of the method, the method is characterized by the additional feature a. listed directly below:
a. bringing the adhesive film in contact with the surface to which the adhesive film is to be applied using an elastic membrane, which can be deflected for pressing the adhesive film onto the surface to which the adhesive film is to be applied.

The use of an elastic membrane for pressing the adhesive film onto the surface to which the adhesive film is to be applied is most particularly advantageously suitable for the method according to the invention since, in this way, not only a particularly uniform bonding process can be achieved, but particularly advantageously the process can also be automated. To enable the deflectability, an edge-side mounting of the elastic membrane, for example in a suitable frame, is preferably provided.

With respect to the deflection of the elastic membrane, the method according to the invention is particularly preferably characterized by the additional feature a. listed directly below:
a. deflecting the elastic membrane by generating a negative pressure, in particular a vacuum, in a space between the elastic membrane and the surface of the component.

In this embodiment of the method, the adhesive film, which, for example, adheres to the aforementioned carrier film or is mounted in another manner, is situated between the elastic membrane and the surface of the component. By generating a negative pressure in the space between the elastic membrane and the surface of the component, the elastic membrane is pulled in the direction of the component, whereby the adhesive film comes in contact with the surface of the component. Negative pressure shall be understood to mean that the pressure is lower than atmospheric pressure (atmospheric pressure≈1 bar). The negative pressure is preferably in a range between 0.01 mbar and 1 bar, and particularly preferably between 0.01 mbar and 750 mbar. Particularly preferably, the pressure is below 0.05 mbar. For example, the pressure may be approximately 0.02 mbar.

The deflection of the membrane initially results in a localized contact region at the surface of the component which results from the curvature of the membrane. During the further course, the other regions of the membrane are also increasingly pulled against the surface, so that the contact region spreads radially outwardly until the adhesive layer is in contact with the surface across the entire surface area.

Such a procedure is hardly possible with a conventional manual application of an adhesive film. To ensure correct positioning of the adhesive film on the surface during a manual application, an edge of an adhesive film in general first has to be manually aligned and then pushed on.

Further deflection of the membrane can in particular be achieved by increasing the pressure on the side of the elastic membrane which faces away from the component. Overall, the deflection of the membrane can be achieved by the generation of a pressure differential. In particular, the pressure in the space between the elastic membrane and the surface of the component is lower than on the other side of the membrane.

The pressure differential can be achieved, for example, in that a vacuum is present between the elastic membrane and the surface of the component, and that atmospheric pressure is present or generated on the other side of the membrane. In other designs, atmospheric pressure may be present between the elastic membrane and the surface of the component. To generate the pressure differential, a positive pressure (positive pressure—pressure higher than atmospheric pressure) is generated on the other side of the membrane in these instances, so that the elastic membrane is deflected in the direction of the component. This also causes the adhesive film arranged between the elastic membrane and the surface of the component, leading with the surface-activated and moistened adhesive layer, to be pushed against the surface of the component.

To adjust the pressure differential, for example, a negative pressure chamber, which is situated in the space between the elastic membrane and the surface of the component, and a pressure equalization chamber, which is situated on the side of the membrane facing away therefrom, can first be evacuated. Thereafter, the pressure equalization chamber is ventilated so that atmosphere pressure arises on this side again, which deflects the elastic membrane in the direction of the component.

A particular advantage of the method according to the invention is that the method is amenable to automation. In a particularly preferred manner, the method is thus carried out with the aid of an automated system. In particular in this embodiment, the method can be used particularly advantageously in motor vehicle production, for example. In this case, the component to which the adhesive film is to be applied is preferably a motor vehicle body or a part of a motor vehicle body or an attachment part of a motor vehicle. In this embodiment, the method preferably comprises two or more, and in particular all, of steps a. to d. listed directly below:
a. coating a motor vehicle body or parts of a motor vehicle body with at least one paint;
b. drying and/or curing the at least one paint;
c. optionally installing attachment parts to supporting components of the motor vehicle body coated with the dried and/or cured at least one paint; and
d. applying the adhesive film, which comprises an adhesive layer, to a surface of the motor vehicle body or parts of the motor vehicle body or an attachment part installed thereon coated with the dried and/or cured at least one paint.

The application of the adhesive film according to the aforementioned feature d. is preferably carried out in the manner described above.

The at least one paint is preferably a conventionally multi-layer automotive paint. Vehicle bodies and body parts are generally primed, painted with a base coat, and subsequently provided with a clear coating material. The work and intermediate steps required to do so are known. For the present invention, it is only important that the at least one paint on the substrate to which the adhesive film is to be applied is preferably dried and cured, that is, offers a substantially pressure-resistant surface and no longer contains solvent. A clear coat application is generally not required or provided for after the adhesive film has been applied in accordance with the invention.

The term “attachment part” is to be broadly interpreted in the context of the invention. This encompasses non-painted parts, such as window panes or headlights on the one hand, but on the other hand also painted parts, such as an engine hood, a door, a fender and a roof element or colored plastic parts. Optionally, a paint was applied to these attachment parts separately from the motor vehicle body and was dried and/or cured.

The invention furthermore comprises a device for applying an adhesive film onto a surface of a component. This device is in particular configured for carrying out the above-described method according to the invention. The device according to the invention is characterized by features a. to d. listed directly below:
a. the device comprises a unit for receiving an adhesive film including an adhesive layer;
b. the device comprises a unit for the physical surface activation of the adhesive layer of the adhesive film;
c. the device comprises a unit for moistening the adhesive layer of the adhesive film;
d. the device comprises a unit for bringing the surface-activated and moistened adhesive film in contact with the surface of the component to which the adhesive film is to be applied.

With respect to further details of the device, reference is also made to the above description in connection with the described method according to the invention.

The unit for receiving the adhesive film including the adhesive layer can in particular be a carrier film, which is provided for positioning the adhesive film in the region of the surface of the component to which the adhesive film is to be applied. The adhesive film preferably adheres with the side thereof facing away from the adhesive layer to the carrier film. The carrier film can preferably be fixed in or to a frame. For this purpose, the carrier film can have positioning and fixation means, which facilitate the fixation to the frame.

The adhesive film is expediently arranged at the carrier film in such a way that the carrier film, together with the adhesive film, is situated between a unit for pressing the adhesive film onto the component, in particular an elastic membrane, and the surface of the component to which the adhesive film is to be applied. Since the adhesive film, in general including the edges thereof, is to be pressed against the surface to which the adhesive film is to be applied, the carrier film facilitates the positioning thereof. After the adhesive film has been pressed on, the carrier film is preferably peeled off the adhesive film.

As an alternative to the carrier film, other units for receiving the adhesive film can also be provided, for example hooks or similar mechanical fastening means into which the adhesive film is hung.

With respect to the unit for the physical surface activation of the adhesive layer, the device according to the invention is preferably characterized by at least one of the additional features a. to d. listed directly below:
a. the unit for the surface-activation of the adhesive layer comprises a unit for generating a plasma;
b. the unit for the surface-activation of the adhesive layer comprises a unit for corona treatment;
c. the unit for the surface-activation of the adhesive layer comprises a unit for flame treatment;
d. the unit for the surface-activation of the adhesive layer comprises a unit for generating a vacuum.

The unit for generating a plasma or the unit for corona treatment or the unit for flame treatment can be units that are known per se to a person skilled in the art, which can generally be used for activating surfaces. With respect to the unit for generating a plasma, in particular low-pressure plasma units are preferred. For generating the low pressure, and in particular for generating a vacuum, an evacuation unit is particularly advantageously provided, into which the adhesive layer of the adhesive film is introduced, so that the plasma treatment can be carried out under vacuum.

With respect to the unit for moistening the adhesive layer of the adhesive film, the device according to the invention is preferably characterized by the following additional feature:
a. the unit for moistening the adhesive layer comprises an atomization unit, and in particular a water atomizer.

The atomization unit is an ultrasonic atomizer, for example, by way of which the droplet size in the created mist can be adjusted and regulated in a particularly suitable manner. Furthermore, a spray gun can be used for this purpose.

With respect to the unit for bringing the adhesive film in contact with the surface to which the adhesive film is to be applied, the device according to the invention preferably comprises at least one of the additional features a. and b. listed directly below:
a. the unit for bringing the adhesive film in contact with the surface to which the adhesive film is to be applied comprises a deflectable elastic membrane for pressing the adhesive film onto the surface of the component to which the adhesive film is to be applied;
b. the unit for bringing the adhesive film in contact with the surface to which the adhesive film is to be applied comprises at least one ram means for bringing the adhesive film in contact with the surface to which the adhesive film is to be applied in a localized manner.

The ram means can preferably be formed with an in particular rounded ram head, an extendable piston, and an actuatable cylinder. With respect to further details regarding the at least one ram means, reference is also made to the above description.

With respect to the elastic membrane, the device can in particular be characterized by at least one of features a. to c. listed directly below:
a. the elastic membrane is made of an elastic polymer material, and in particular of natural rubber or silicone;
b. the elastic membrane has a uniform thickness;
c. the elastic membrane has weakening and/or reinforcement regions for deliberately influencing the geometry of the curved state.

Particularly preferably, either features a. and b., or a. and c., listed directly above are implemented in combination with one another.

Influencing the geometry of the curved state of the membrane can be helpful during the formation of the aforementioned localized contact region. If, for example, a depression is present in the surface to which the adhesive film is to be applied, the localized contact region should ideally arise at the lowest point of the depression. It may be preferred to avoid the formation of a circular contact region, since otherwise trapped air could occur.

If the elastic membrane is designed to be thinner, for example, in one region than in another region, it will curve more easily and more extensively in this region than in the remaining regions when a pressure or negative pressure is applied. The opposite applies in the case of a reinforcement of the elastic membrane.

The introduction of weakening and/or reinforcement regions into the elastic membrane can furthermore be expedient for influencing the extension of the contact region. This can be advantageous in particular when adhesively attaching the adhesive film to bent surfaces, and in particular to surfaces including depressions.

The device can preferably be configured in such a way that the elastic membrane can be deflected by means of a pressure differential, and in this way presses the adhesive film against the surface of the component to which the adhesive film is to be applied.

The device according to the invention is preferably characterized by the additional feature a. listed directly below:
a. the unit for bringing the adhesive film in contact with the surface to which the adhesive film is to be applied comprises a unit for generating a negative pressure in a space between the elastic membrane and the surface of the component for deflecting the elastic membrane.

In a refinement of this aspect of the device according to the invention, the unit for bringing the adhesive film in contact with the surface to which the adhesive film is to be applied furthermore comprises a unit for increasing the pressure on the other side of the elastic membrane compared to the negative pressure generated in the space between the elastic membrane and the surface of the component. This unit for increasing the pressure on the other side of the elastic membrane can be a vent valve in a pressure equalization chamber, for example. In this embodiment, in particular a negative pressure chamber can be provided in the space between the elastic membrane and the surface of the component, and a pressure equalization chamber can be provided on the other side of the membrane. For the deflection of the elastic membrane, it may be provided that initially negative pressure is applied to both the negative pressure chamber and the pressure equalization chamber, wherein in particular an evacuation of both spaces for generating a vacuum may be provided. In this state, the elastic membrane is not yet deflected since the same pressure (vacuum) arises on both sides of the membrane. After the vacuum has been reached, the pressure in the pressure equalization chamber can be equalized compared to the ambient atmospheric pressure by the actuation of the vent valve, so that the pressure in the pressure equalization chamber increases compared to the negative pressure chamber. This measure causes the elastic membrane to deflect in the direction of the component, whereby the interposed adhesive film, leading with the surface-activated and moistened adhesive layer, is pressed against the surface of the component to which the adhesive film is to be applied.

The component to which the adhesive film is to be applied can in particular be an essentially fully painted body part of a motor vehicle or another painted component or workpiece. The component can in particular also already be provided with a clear coat. In principle, differing components are suitable underlying surfaces for the adhesive film to be applied. As a result of the optimization according to the invention of the process of applying the adhesive film to the surface, it is also possible to accordingly apply adhesive film to components that are typically more problematic.

In a particularly preferred design, the device according to the invention comprises the additional feature a. listed directly below:
a. the device comprises a frame, which is designed to form, together with the surface to which the adhesive film is to be applied and the elastic membrane, a negative pressure chamber in which the adhesive film is arranged and in which the elastic membrane can curve when negative pressure is applied to the negative pressure chamber.

As was already described, it is particularly advantageous to apply a negative pressure in the region between the surface to which the adhesive film is to be applied and the elastic membrane when applying the adhesive film. The frame is provided for this purpose.

For temperature control purposes, the elastic membrane can have a double-wall design and have connections for a temperature control medium, such as water.

The means for fixing the adhesive film or the carrier film can be pins or hooks, for example, which correspond to holes in the adhesive film or the carrier film.

In a preferred refinement of the invention, the device is characterized by at least one of features a. to f. listed directly below:
a. the frame has a rectangular shape;
b. the frame has a first opening, which is closed by the membrane;
c. the frame comprises at least one elastic sealing element, which can sealingly rest on the surface;
d. the frame comprises a second opening, to the edges of which the at least one elastic sealing element is fixed;
e. the frame comprises at least one connection for a negative pressure source, by way of which negative pressure can be applied to the negative pressure chamber;
f. the frame comprises at least one mount as a means for fixing the adhesive film.

Preferably, at least features a. to e. listed directly above are implemented in combination with one another, and particularly preferably all features a. to f.

The at least one sealing element is used to seal the negative pressure chamber. They are preferably made of elastic polymer materials, for example the aforementioned natural rubber. The at least one connection for the negative pressure source is used to generate the negative pressure in the negative pressure chamber.

In a further preferred refinement of the invention, the device is characterized by at least one of features a. to d. listed directly below:
a. the frame is composed of two or more sub-frames;
b. the frame has a rectangular shape and is composed of the two or more rectangular sub-frames;
c. the frame comprises a first rectangular sub-frame, to which the at least one elastic sealing element is fixed and which comprises the at least one connection for the negative pressure source;
d. the frame comprises a second rectangular sub-frame, which comprises the at least one mount for the adhesive film.

Preferably, at least features a. to c. listed directly above are implemented in combination with one another, and particularly preferably all features a. to d.

When using two or more sub-frames, it may be necessary to provide further sealing elements at connecting surfaces of the sub-frames to ensure tightness of the negative pressure chamber.

For the purpose of the above-described control or regulation of the negative pressure, the device can comprise a suitable control or regulating unit.

In a further preferred refinement of the invention, the device is characterized by at least one of features a. to c. listed directly below, and preferably by a combination of features a. and b., or a. and c., listed directly below:
a. the device comprises a pressure equalization chamber, which is delimited, amongst others, by the membrane;
b. the device comprises at least one connection fora pressure or negative pressure source, which leads into the pressure equalization chamber;
c. the device comprises at least one valve, by way of which the pressure equalization chamber can be ventilated.

This pressure equalization chamber is optionally required to create or enhance the described curvature of the elastic membrane. When a negative pressure is applied in the negative pressure chamber, it may be entirely sufficient for this purpose to ventilate the pressure equalization chamber by way of the valve in order to effectuate or enhance the required curvature of the membrane.

The device is particularly preferably integrated into an automated system, for example into a robot. The automated system is preferably a manufacturing line for producing motor vehicles.

In principle, the described method and the described device are, of course, not just suitable for use in the production of motor vehicles. According to the invention, other series products, for example, can also be provided with adhesive films, such as bicycles.

Further features and advantages of the described invention will be apparent from the following description of exemplary embodiments in conjunction with the drawings, in which preferred embodiments of the device according to the invention, or parts of the device, for applying an adhesive film to a component are shown. The illustrated and described embodiments only serve to explain and provide a better understanding of the invention, and in no way shall be construed to be limiting.

### BRIEF DESCRIPTION OF THE DRAWINGS

In the drawings:

FIG. 1 shows a schematic sectional illustration of a preferred embodiment of a part of the device according to the invention for applying an adhesive film to the surface of a component;

FIG. 2 shows a schematic sectional illustration of a further preferred embodiment of a part of a device according to the invention for applying an adhesive film to the surface of a component;

FIG. 3 shows a schematic sectional illustration of a further preferred embodiment of a part of a device according to the invention for applying an adhesive film to the surface of a component;

FIG. 4 shows a sectional view through a treatment hood as an integral part of a device according to the invention for applying an adhesive film to the surface of a component; and

FIG. 5 shows a side view of the treatment hood from FIG. 4 at a robotic arm.

### DETAILED DESCRIPTION OF THE EXEMPLARY EMBODIMENTS

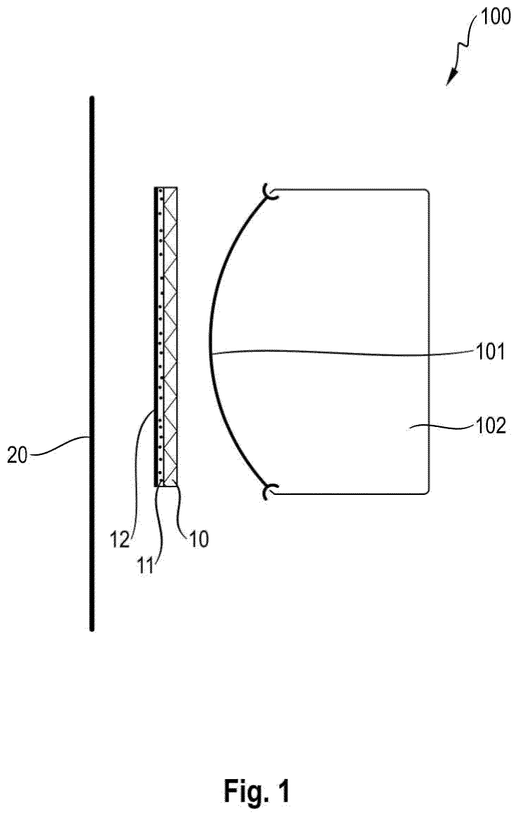

FIG. 1 shows a schematic sectional view of a part of a device 100 for applying an adhesive film 10 to the surface 20 of a component. The adhesive film 10 is provided with an adhesive layer 11 on the side facing the component. In accordance with the method according to the invention, the adhesive layer 11 was subjected to a physical surface activation and thereafter moistened with water vapor, so that a water film 12 has formed on the adhesive layer 11.

The unit for the physical surface activation of the device 100 not shown in greater detail here is preferably a plasma treatment unit. The plasma treatment preferably takes place under vacuum, so that further more an evacuation unit is provided. As an alternative, a corona treatment unit or a flame treatment unit may be provided.

To create the water film 12, the device 100 comprises an atomization unit not shown here in greater detail, preferably an ultrasonic atomizer, or a spray gun or a comparable spraying unit.

A deflectable, elastic membrane 101 is provided for pressing on the adhesive film 10 that has been surface-activated and moistened on the adhesive side. A positive pressure chamber 102 is provided on the side of the elastic membrane 101 which faces away from the adhesive film 10. The positive pressure (positive pressure: >1 bar) is generated by means for generating a positive pressure in the positive pressure chamber 102, which are not shown in greater detail here. The positive pressure deflects the elastic membrane 101 in the direction of the surface 20 of the component in that the elastic membrane 101 convexly protrudes. During the further convex protrusion of the elastic membrane 101 in the direction of the surface 20 of the component not shown in greater detail here, the interposed adhesive film 10 is increasingly pushed against the surface 20 of the component, resulting in adhesion of the adhesive surface 10 to the surface 20 of the component by means of the surface-activated and moistened adhesive layer 11.

For the surface activation and the moistening of the adhesive layer 11 of the adhesive film 10, initially receiving the adhesive film 10 in a treatment hood can be provided, which is not shown in greater detail in this figure, wherein the adhesive layer 11 of the adhesive film 10 is oriented toward the open side of the treatment hood. A carrier film, to which the adhesive film adheres with the side facing away from the adhesive layer, can be provided for receiving the adhesive film 10 in the treatment hood. In the process, first the adhesive film 10 is attached to the carrier film, and then the carrier film is inserted into the treatment hood. The treatment hood including the adhesive film 10 is positioned at a plasma generation unit, which in particular comprises a corresponding plate including an electrode. An evacuation for generating a vacuum in the interior of the treatment hood is carried out in the now sealed space of the treatment hood, so that the plasma treatment of the adhesive layer 11 provided according to the invention can be carried out. Thereafter, the treatment hood, including the adhesive film that is present therein and includes the surface-activated adhesive layer, can be positioned at a moistening station, which is not shown here and in which the surface-activated adhesive layer 11 is moistened by means of an atomization unit, and in particular an ultrasonic atomizer.

Thereafter, the treatment hood, including the adhesive film 10 that is present therein and includes the surface-activated and moistened adhesive layer 11, can be positioned at the component to which the adhesive film is to be applied, for example at a motor vehicle body. The adhesive film 10 is then in particular pressed onto the surface 20 of the component to which the adhesive film is to be applied by means of the described elastic membrane 101, wherein the adhesive film 10 detaches from the optionally provided carrier film. The treatment hood can now be positioned in an ejection station for removing the carrier film. After the carrier film has been removed, the treatment hood is available again for another pass.

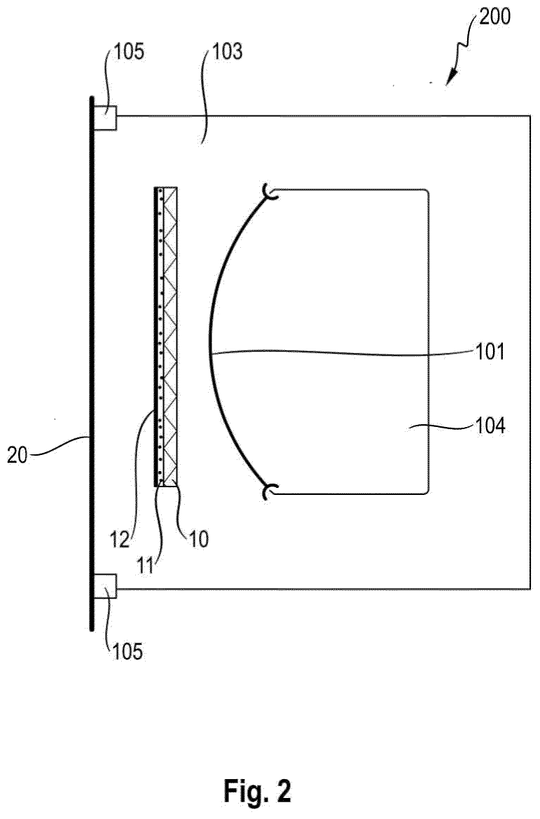

FIG. 2 shows a further preferred design of a part of a device 200 for applying an adhesive film 10 including an adhesive layer 11 to the surface 20 of a component. Here as well, the adhesive film 10 is pressed onto the surface 20 of the component by means of a deflectable, elastic membrane 101.

In contrast to the design of the device in FIG. 1, a space 103 that is designed as a negative pressure chamber is provided in the device 200 shown in FIG. 2 between the deflectable elastic membrane 101 and the surface 20 of the component. The pressure-tightness of the negative pressure chamber 103 is ensured by seals 105, wherein these seals 105 seal the bounds of the negative pressure chamber 103 with respect to the surface 20 of the component.

A negative pressure is applied in the negative pressure chamber 103 for pressing the adhesive film 10 onto the surface 20 of the component, wherein an evacuation is preferably carried out for generating a vacuum by means not shown in greater detail here. Atmospheric pressure continues to be present in the space 104 situated on the other side of the membrane 101, so that the pressure differential between the space 104 and the negative pressure chamber 103 causes the elastic membrane 101 to be deflected in the direction of the surface 20 of the component. As a result of this deflection of the membrane 101, the adhesive film 10, leading with the surface-activated and moistened adhesive layer 11 present thereon, is pressed against the surface 20 of the component.

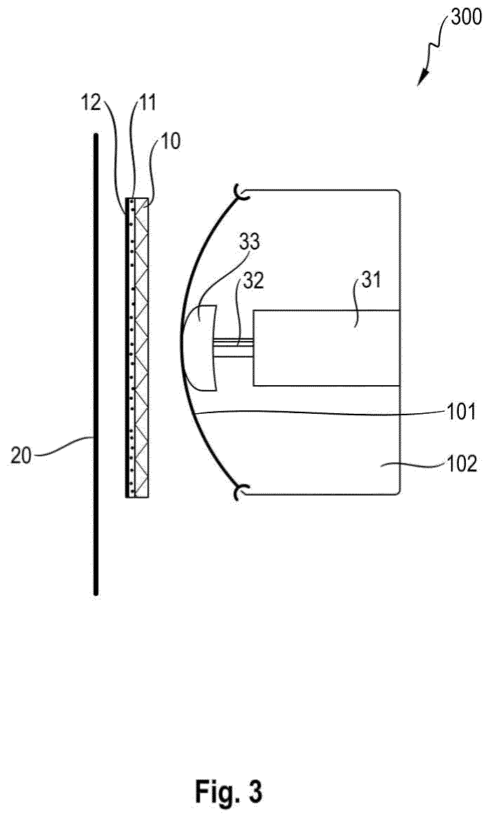

FIG. 3 shows a schematic sectional view of a further, particularly preferred embodiment of a part of a device 300 according to the invention for applying an adhesive film 10 including an adhesive layer 11 to the surface 20 of a component. In a manner corresponding to the embodiments shown in FIG. 1 and in FIG. 2, the adhesive layer 11 of the adhesive film 10 here has also been exposed to a physical surface activation and moistening for forming a water film 12 on the adhesive layer 11 of the adhesive film 10. The embodiment of the device 300 in large parts corresponds to the embodiment 100 shown in FIG. 1, wherein a deflectable membrane 101 is provided here in a corresponding manner, which can be deflected by means of a positive pressure in the positive pressure chamber 102 in the direction of the surface 20 of the component, and in this way causes the adhesive film 10, leading with the adhesive layer 11, to be pressed against the surface 20 of the component. A ram means including an actuatable cylinder 31, an extendable piston 32, and a ram head 33 is additionally provided in this embodiment. By means of this ram means, the adhesive film 10 can be deliberately pushed against the surface 20 of the component in a localized manner by way of the interposed membrane 101. As a result, it is above all achieved that, from a central starting point, the surface-activated and moistened adhesive layer 11 of the adhesive film 10 is uniformly placed against the surface 20 of the component in a radially outwardly progressing manner. This facilitates a particularly uniform and reliable application of the adhesive film 10.

Similarly, such a ram means 31, 32, 33 can also be used for devices in which the adhesive film 10 is applied to the surface 20 of a component by means of a negative pressure, for example in the device 200 of FIG. 2. In such designs for the application of the adhesive film 10, it is possible, in particular in the case of particularly pressure-sensitive components, for the component to become deformed by the applied negative pressure, and in particular to protrude in the direction of the device 200. Such a protrusion can be counteracted by an accordingly extended ram means 31, 32, 33, so that the ram means additionally serves to stabilize a pressure-sensitive and possibly particularly flexible component.

It is particularly preferred that the advancement of the ram means 31, 32, 33 and the adjustment of the pressure differential, and in particular the adjustment of a negative pressure, take place concurrently. It is expediently taken into consideration in the process that a deformation of pressure-sensitive components may optionally occur right at the start of the evacuation, so that the ram means 31, 32, 33 is advantageously extended right at the start of the evacuation until contact is made with the component.

An advancement of the ram head 33 is preferably carried out in coordination with the adjustment of the negative pressure. In other words, the adjustment of the pressure differential, which results in a deflection of the elastic membrane 101, and the advancement of the ram means 31, 32, 33 are preferably matched to one another. The coordination of the advancement of the ram head 33 with the adjustment of the negative pressure can in particular take place by matching these steps in terms of time or as a function of the actual negative pressure that arises. In a particularly preferred manner, the ram means 31, 32, 33 is advanced in a controlled or regulated manner. The actuation of the ram means is in particular designed in such a way that the force acting on the component as a result of the pressure differential during the process of applying the adhesive film 10 to the component is compensated for, resulting in an equilibrium of forces.

It may be provided that the ram means 31, 32, 33 is extended as a function of time. For example, the ram means 31, 32, 33 can be extended after several seconds have elapsed or after a predefinable time interval has elapsed, for example after 2 s or 3 s or 4 s or 5 s, after the start of an evacuation.

In other designs, the ram means 31, 32, 33 can be extended as a function of an actually measured pressure acting on the membrane 101, that is, in particular when a drop below a predefinable pressure threshold occurs during the adjustment of the negative pressure. In this embodiment, one or more pressure sensors may advantageously be used. For example, the ram means 31, 32, 33 can be extended when a pressure of 100 mbar or another pressure threshold is reached. Such control can in particular also be matched to the properties of the component to which the adhesive film is to be applied and can in particular be adapted as a function of the pressure sensitivity of the particular component.

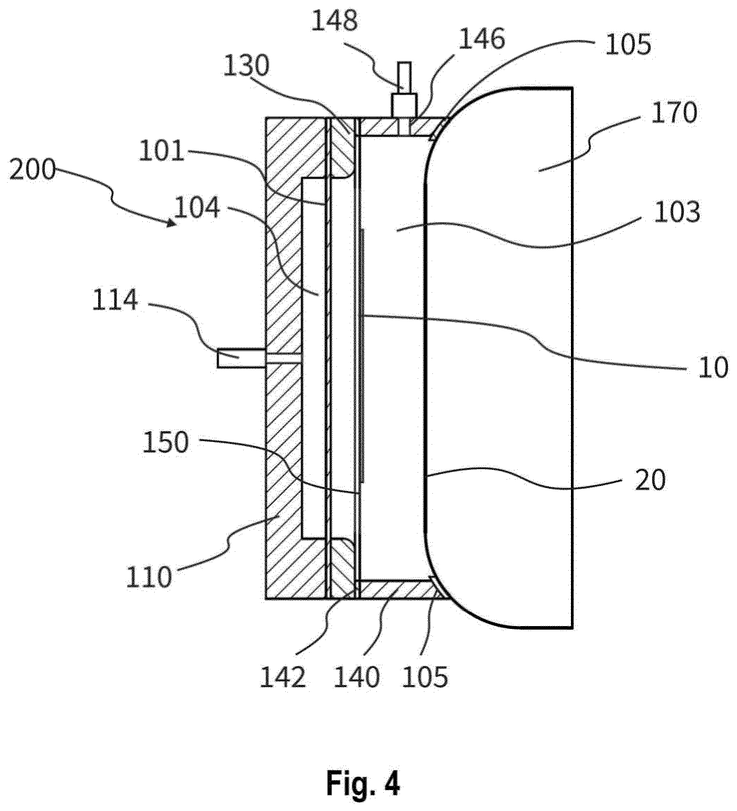

FIG. 4 shows a side view of a treatment hood 200, which corresponds to the device 200 from FIG. 2 in terms of the basic design. Corresponding elements are thus denoted by like reference numerals. With the aid of the treatment hood 200, the adhesive film 10 can, for example, be applied to a painted surface 20 of a motor vehicle.

The treatment hood 200 comprises a rectangular frame, which is composed of a rectangular sub-frame 130 and a rectangular sub-frame 140. The sub-frames 130 and 140 are connected in an air-tight manner by way of a seal 142. A carrier film 150 is fixed in the sub-frame 130, for example by means of several pins. For this purpose, the carrier film 150 can have several corresponding holes into which the pins can be pushed.

The elastic membrane 101, which is made of natural rubber, for example, is arranged parallel to the carrier film 150. The membrane is clamped between a base plate 110 of the treatment hood 200 and the sub-frame 130 in an air-tight manner. It closes the opening of the frame defined by the sub-frame 130. For this purpose, for example, several screws are screwed through the sub-frame 130 into the base plate 110. Together with the elastic membrane 101, the base plate 110 encloses the pressure equalization chamber 104. Air can be allowed to enter the pressure equalization chamber 104 by way of a valve 114.

The frame composed of the sub-frames 130 and 140, together with the surface 20 of the component 170 to which the adhesive film is to be applied and with the elastic membrane 101, is designed to form the negative pressure chamber 103, in which the carrier film 150 including the adhesive film 10 is arranged and in which the elastic membrane 101 can curve when negative pressure is applied to the negative pressure chamber 103. The sub-frame 140 is adapted to the geometry of the surface 20 for this purpose, so that form-locked contact is ensured between the surface 20 and the sub-frame 140 of the treatment hood 200. The elastic sealing element 105 is fixed to the edges of the opening of the frame which is defined by the sub-frame 140. The frame is sealingly connected to the surface 20 by way of this sealing element. The negative pressure chamber 103 can be evacuated via a connection 148 that is coupled to a negative pressure source and the channel 146 that is routed through the sub-frame 140. In the state shown here, the elastic membrane 101 is not curved, which means that the same pressure is present in the pressure equalization chamber 104 and in the negative pressure chamber 103.

A pressure differential is generated between the negative pressure chamber 103 and the pressure equalization chamber 104 for deflecting the elastic membrane 101, wherein the higher pressure is set in the pressure equalization chamber 104. This can in particular be achieved by initially evacuating both the negative pressure chamber 103 and the pressure equalization chamber 104. Thereafter, the pressure equalization chamber 104 is ventilated by way of the valve 114, so that the pressure in the pressure equalization chamber 104 approaches atmospheric pressure again. As a result, the elastic membrane 101 curves in the direction of the surface 20 of the component 170, thereby pushing the adhesive film 10, which has been surface-activated and moistened in accordance with the invention, onto the surface 20 of the component.

After the pressing of the adhesive film 10 against the surface 20 of the component 170 has been completed, the negative pressure chamber 103 and the pressure equalization chamber 104 can be fully ventilated. The elastic membrane 101 can then return to the original state. In general, the carrier film 150 is peeled off the adhesive film 10 in the process, and the adhesive film 10 remains on the surface 20.

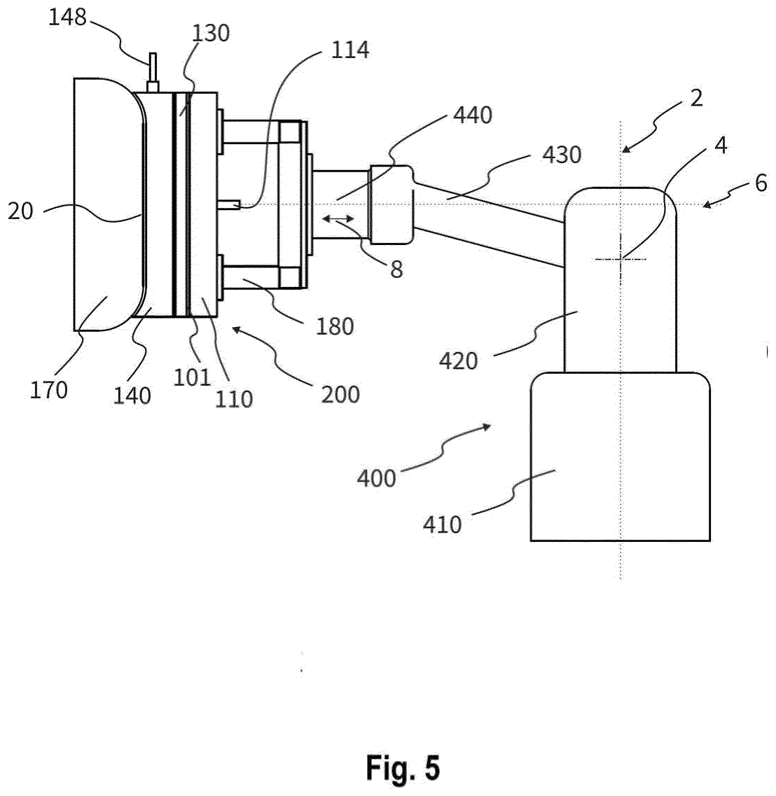

FIG. 5 shows an embodiment of the device according to the invention in which the treatment hood 200 is coupled by way of a substructure 180, which is situated on one side of the base plate 110 of the treatment hood 200, to a robotic arm 430 or, generally speaking, to lifting gear of an automated system 400. The automated system 400 is provided with a base 410 including a pivotable upper part 420. The upper part 420 can rotate freely about an axis of rotation 2. The robotic arm 430 can be pivoted about a pivot axis 4. This allows a height adjustment of the treatment hood 200.

A push cylinder 440 is arranged between the robotic arm 430 and the treatment hood 200. The push cylinder 440 can be linearly expanded along a displacement direction 8. The push cylinder 440 can additionally be rotated about an axis of rotation 6. As a result, a precise distance and alignment between the treatment hood 200 and the surface 20 of the component can be set.

With the aid of the automated system 400, the treatment hood 200, including the adhesive film 10 present herein, can run through various stations for carrying out the described steps for the surface activation and the moistening of the adhesive layer 11 of the adhesive film 10. With respect to the various stations of the treatment hood, in particular an evacuation unit and a plasma treatment unit as well as a moistening unit, reference is also made to the description of FIG. 1.

1. A method for applying an adhesive film to the surface of a component, comprising:
a. carrying out a physical surface activation of an adhesive layer of an adhesive film;
b. moistening the adhesive layer of the adhesive film; and
c. bringing the surface-activated and moistened adhesive film in contact with a surface of the component to which the adhesive film is to be applied.

2. The method according to claim 1, further comprising at least one of the following:
a. carrying out the physical surface activation of the adhesive layer by a plasma treatment;
b. carrying out the physical surface activation of the adhesive layer by a corona treatment;
c. carrying out the physical surface activation of the adhesive layer by a flame treatment; and
d. carrying out the physical surface activation of the adhesive layer under vacuum.

3. The method according to claim 1, further comprising:
a. moistening the adhesive layer by the atomization of water.

4. The method according to claim 1, further comprising:
a. bringing the adhesive film in contact with the surface to which the adhesive film is to be applied by initially pressing the adhesive film in a localized manner onto the surface to which the adhesive film is to be applied.

5. The method according to claim 1, further comprising:
a. bringing the adhesive film in contact with the surface to which the adhesive film is to be applied using an elastic membrane, which can be deflected for pressing the adhesive film onto the surface to which the adhesive film is to be applied.

6. The method according to claim 5, further comprising:
a. deflecting the membrane by generating a negative pressure in a space between the elastic membrane and the surface of the component.

7. A device for applying an adhesive film to a surface of a component, comprising:
a. a unit for receiving an adhesive film including an adhesive layer;
b. a unit for the physical surface activation of the adhesive layer of the adhesive film;
c. a unit for moistening the adhesive layer of the adhesive film;
d. a unit for bringing the surface-activated and moistened adhesive film in contact with the surface of the component to which the adhesive film is to be applied.

8. The device according to claim 7, further comprising at least one of the following:
a. the unit for the surface-activation of the adhesive layer comprises a unit for generating a plasma;
b. the unit for the surface-activation of the adhesive layer comprises a unit for corona treatment;
c. the unit for the surface-activation of the adhesive layer comprises a unit for flame treatment;
d. the unit for the surface-activation of the adhesive layer comprises a unit for generating a vacuum.

9. The device according to claim 7, further comprising:
a. the unit for moistening the adhesive layer comprises an atomization unit, and in particular a water atomizer.

10. The device according to claim 7, further comprising at least one of the following:
a. the unit for bringing the adhesive film in contact with the surface to which the adhesive film is to be applied comprises a deflectable elastic membrane for pressing the adhesive film onto the surface of the component to which the adhesive film is to be applied.
b. the unit for bringing the adhesive film in contact with the surface to which the adhesive film is to be applied comprises at least one ram means for bringing the adhesive film in contact with the surface to which the adhesive film is to be applied in a localized manner.

11. The device according to claim 10, further comprising:
a. the unit for bringing the adhesive film in contact with the surface to which the adhesive film is to be applied comprises a unit for generating a negative pressure in a space between the elastic membrane and the surface of the component for deflecting the elastic membrane.
